(19) United States
(12) Patent Application Publication
(10) Pub. No.: US 2025/0067390 A1
(43) Pub. Date: Feb. 27, 2025

(54) MOUNTING BRACKETS

(71) Applicant: ARRAY TECH, INC., Albuquerque, NM (US)

(72) Inventors: Nathan Schuknecht, Golden, CO (US); Kevin Krautbauer, Phoenix, AZ (US); Graeme Hoste, Albuquerque, NM (US)

(21) Appl. No.: 18/810,073

(22) Filed: Aug. 20, 2024

Related U.S. Application Data
(60) Provisional application No. 63/520,795, filed on Aug. 21, 2023.

(51) Int. Cl. F16M 13/02; H02S 20/32

(52) U.S. Cl. CPC F16M 13/022; H02S 20/32

(57) ABSTRACT

A mounting bracket suitable for facilitating the connection of components in a photovoltaic system may include a unibody piece of metal. The unibody piece of metal may include a first portion, a second portion, and a rigid body. The first portion may form a first plane and be configured to couple with a support column. The first portion may include a first opening. The second portion may form a second plane. The second portion may include an opening to permit the opening to receive a fastener to couple the components to the mounting bracket. The rigid body may overlap at least part of the first portion and be generally parallel to the first plane. The rigid body may include a second opening corresponding to the first opening to permit the second opening and the first opening to both receive a fastener to couple the mounting bracket to the support column.

### CROSS-REFERENCE TO RELATED APPLICATION

This application claims the benefit of and priority to U.S. Patent Application Ser. No. 63/520,795, filed on Aug. 21, 2023, the disclosure of which is incorporated herein by reference.

### THE FIELD OF THE INVENTION

The embodiments discussed in the present disclosure are related to solar installations and, more particularly, to mounting brackets for use in solar installations.

### BACKGROUND

During installation and operation, mounting brackets of solar installations may be exposed to environmental factors that may cause corrosion. Mounting brackets can be made in many ways, including forging, extrusion, or forming and may include holes to interface with adjacent components. In corrosive environments, each mounting bracket is treated with a coating to prevent corrosion. Treating the mounting brackets with the coating usually occurs post manufacturing to ensure all external surfaces of the mounting brackets are sufficiently protected, however this treatment process increases cost, time, and complexity of the manufacturing process for the mounting brackets.

During operation, the mountings brackets are exposed to loads created by components of the solar installations or by external factors acting on the components of the solar installations. Forging mounting brackets using metals that include thicknesses that permit the treatment process to protect the entire depth of the metals may result in mounting brackets that are not be able to withstand the loads. The mounting brackets not being able to withstand these loads may cause the mounting brackets to deform during operation and be replaced often, which may increase the cost for operating the solar installations.

Accordingly, there is a need for an improved manufacturing process that permits mounting brackets to be manufactured without the need to treat each mounting bracket after being formed and that results in mounting brackets that can withstand the loads they are exposed to during operation.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address the problems experienced in solar installations, including problems associated with forming and individually treating the mounting brackets. In addition, exemplary embodiments of the present disclosure include mounting brackets that are able to withstand the loads the mounting brackets are exposed to during operation without forging and individually treating the mounting brackets.

Disclosed embodiments address such problems by providing mounting brackets that are formed using unibody pieces of metal that are cut from one or more sheets of pre-galvanized metal of uniform thicknesses. The uniform thicknesses are such that the treatment process (e.g., a galvanization process) protects the entire depth of the sheets of pre-galvanized metal, which permits the unibody pieces of metal to be bent and openings to be created without exposing portions of the unibody pieces metal that the galvanization process does not protect (generally referred to as unprotected portions). The galvanization process may include coating external surfaces of the metals, which may cause electrochemical reactions that protect portions of the metals up to a certain distance from the coated surfaces. Thus, forming the mounting brackets using the unibody pieces of metal simplifies the manufacturing process by eliminating the need to individually treat the mounting brackets after being formed. In addition, in some embodiments, the unibody pieces of metal may be bent such that the mounting brackets include multilayer structures so that the mounting brackets are able to withstand the loads that they are exposed to during operation. Therefore, forming the mounting brackets using the unibody pieces of metal may reduce the cost, time, and/or complexity of manufacturing the mounting brackets and/or operating the solar installations.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an example solar tracking system;

FIG. 2A illustrates a perspective view of one example of the mounting brackets of FIG. 1;

FIG. 2B illustrates a front view of the example of the mounting brackets of FIG. 1;

FIG. 2C illustrates a rear view of the example of the mounting brackets of FIG. 1;

FIG. 2D illustrates a bottom view of the example of the mounting brackets of FIG. 1;

FIG. 2E illustrates a top view of the example of the mounting brackets of FIG. 1;

FIG. 3A illustrates the example of the mounting brackets of FIG. 1 in a pre-bent state;

FIG. 3B illustrates an example form of multiple examples of the mounting brackets of FIG. 1 in the pre-bent state;

FIG. 4A illustrates a perspective view of another example mounting bracket, including example attachment tabs;

FIG. 4B illustrates a front view of the example mounting bracket including the example attachment tabs;

FIG. 4C illustrates a rear view of the example mounting bracket including the example attachment tabs;

FIG. 4D illustrates a bottom view of the example mounting bracket including the example attachment tabs;

FIG. 4E illustrates a top view of the example mounting bracket including the example attachment tabs;

FIG. 5A illustrates the example mounting bracket of FIGS. 4A-4E in a pre-bent state;

FIG. 5B illustrates another example mounting bracket including example attachment tabs in a pre-bent state;

FIG. 6 illustrates a perspective view of an example mounting bracket including hems;

FIG. 7A illustrates a perspective view of an example drawn mounting bracket;

FIG. 7B illustrates a front view of the example drawn mounting bracket of FIG. 7A;

FIG. 7C illustrates a top view of the example drawn mounting bracket of FIG. 7A;

FIG. 8 illustrates a flowchart of a method;
all according to at least one embodiment described in the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

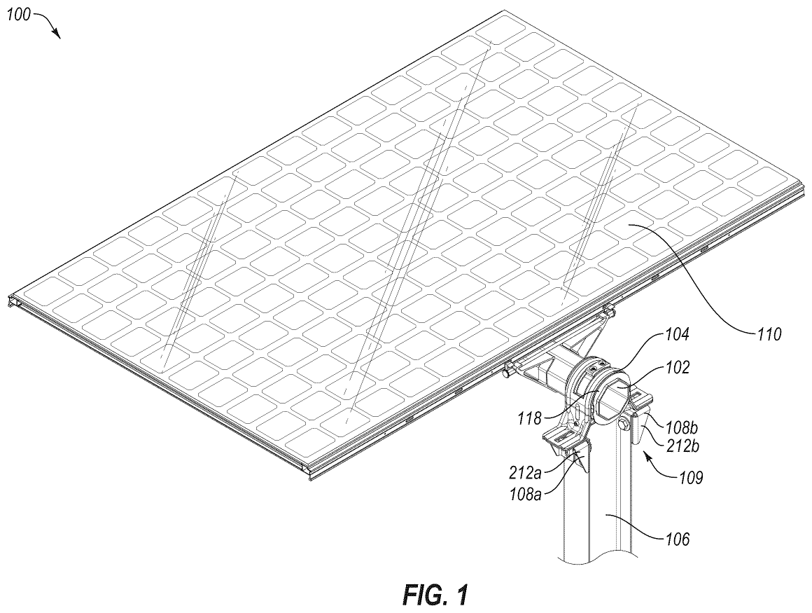

Referring to FIG. 1, an example of one type of system environment in which aspects of the present disclosure might be used is shown. Shown here is an embodiment of a solar tracking system 100, which includes a solar component, which is connected to a support column 106. Although illustrated and described in relation to the solar tracking system 100, it is appreciated that the embodiments described in the present disclosure may be implemented in a solar tracking system, a fixed solar system, or any other appropriate solar system.

In the example shown, a PV module 110 is coupled to the torque tube 102 and the solar component includes a torque tube interface, generally denoted at 109, that connects the torque tube 102 to the support column 106 via mounting brackets 108a-b. The torque tube interface 109 permits the torque tube 102 to rotate to generally to orient the PV module 110 towards the sun or normal to the generally east-west portion of the irradiance of the sun, which may facilitate increased electrical energy generation by the PV module 110.

While embodiments of the mounting brackets 108a-b are described with respect to attachment of the torque tube interface 109, it will be appreciated that variations of the mounting brackets 108a-b can be used to facilitate the attachment of other solar components to the support column 106. For example, the mounting brackets 108a-b may facilitate the attachment of a drive system, a counterbalance spring, a damper, a bearing, a control box, or a torsional lock to the support column 106.

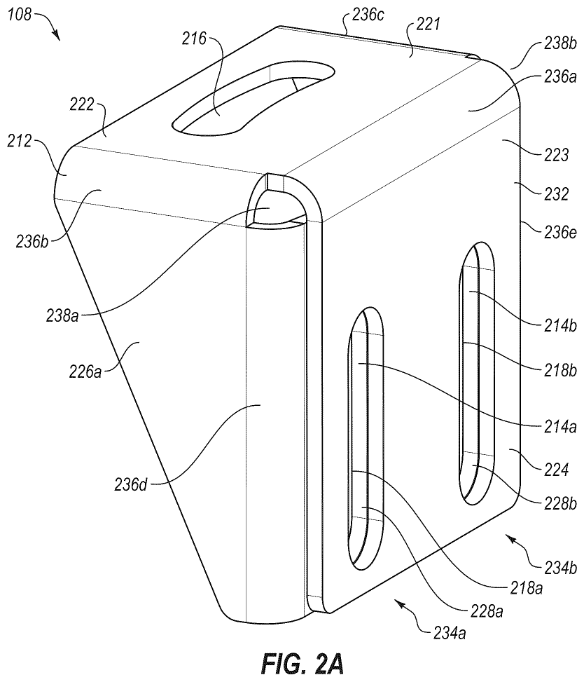

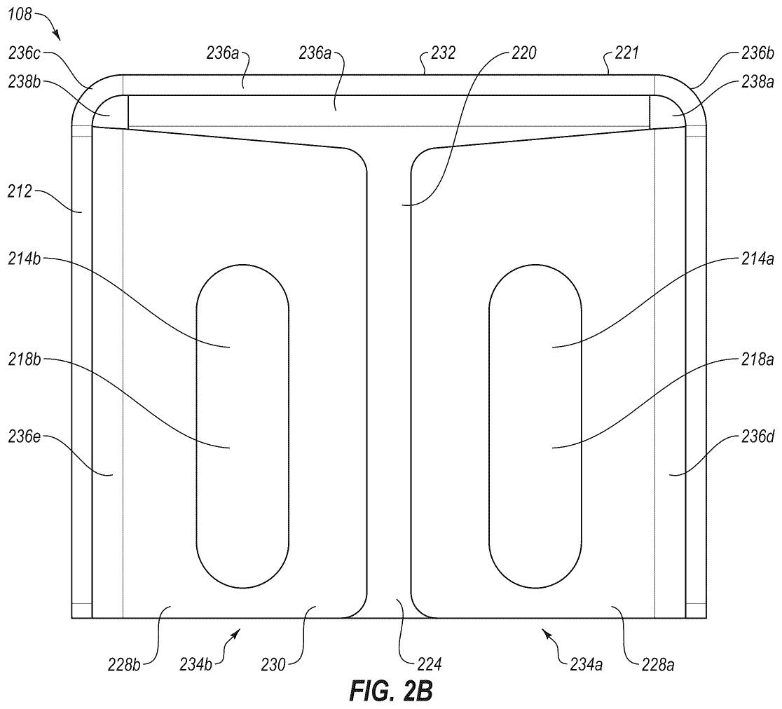

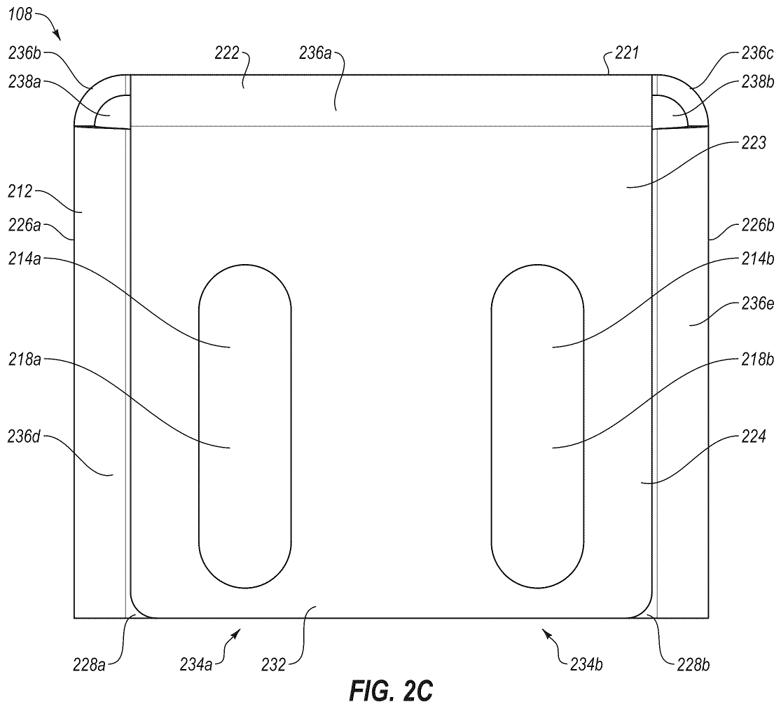

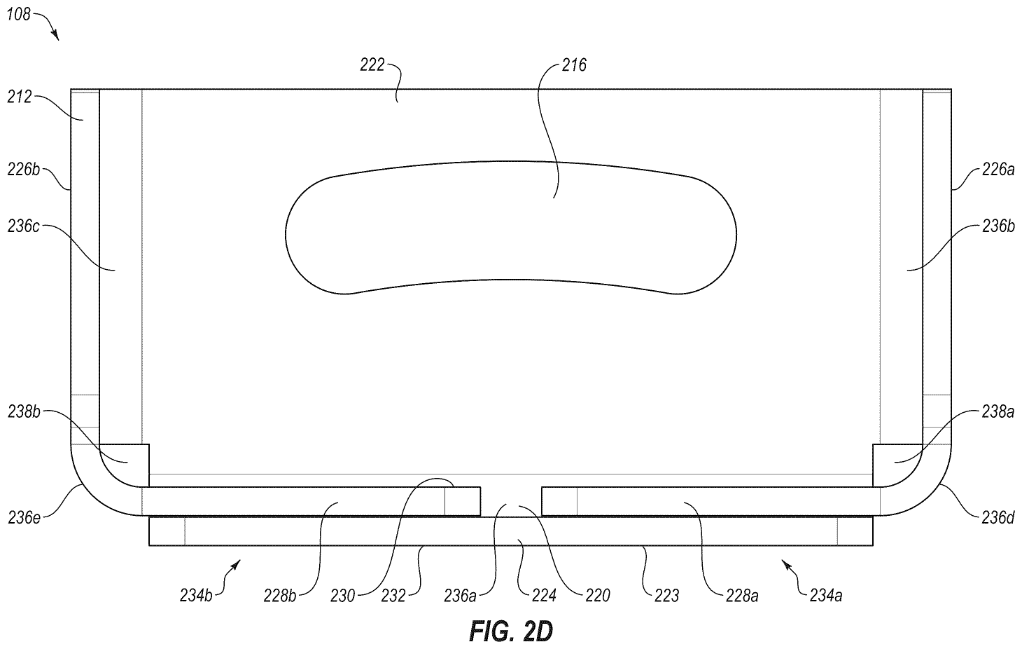

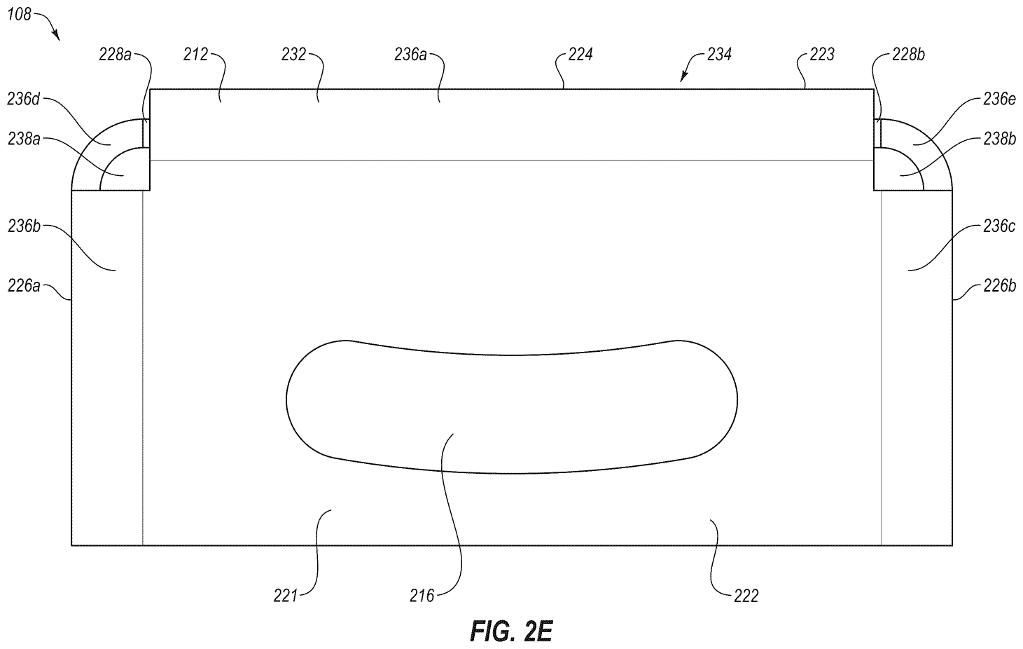

The mounting brackets 108a-b are treated (such as by galvanization) to prevent corrosion due to the environmental factors. For example, the mounting brackets 108a-b may be treated to prevent corrosion due to rain, snow, humidity, sleet, and other environmental factors. In addition, each of the mounting brackets 108a-b are formed using unibody pieces of metal 212a-b. The unibody pieces of metal 212a-b may be cut or stamped from sheets of pre-galvanized metal that include uniform thicknesses such that the galvanization process protects the entire depth of the sheets of metal. Additionally or alternatively, the unibody pieces of metal 212a-b may be pre-cut or stamped and then galvanized when still a sheet of metal. In some embodiments, the unibody pieces of metal 212a-b are bent to form the mounting brackets 108a-b such that the mounting brackets 108a-b include multilayer structures (such as denoted at 234a-b in FIGS. 2A-2D).

With further reference to FIGS. 1 and 2A-2E, the mounting bracket 108 includes the unibody piece of metal 212 that is cut, punched, or otherwise removed from a single sheet of pre-galvanized metal. The unibody piece of metal 212 may be cut from the single sheet of pre-galvanized metal such that the galvanization process protects the entire depth of the unibody piece of metal 212 between a first face 230 and a second face 232. The second face 232 may be on an opposite side of the unibody piece of metal 212 as the first face 230.

The thickness of the unibody piece of metal 212 may permit the unibody piece of metal 212 to be bent, cut, or stamped to form the mounting bracket 108 without exposing unprotected portions of the unibody piece of metal 212. For example, the unibody piece of metal 212 may be cut to create openings 214a-b, 216, 218a-b without exposing the unprotected portions. In other words, the unibody piece of metal 212 may be manipulated while retaining a galvanization pre-treatment that was performed on the single sheet of pre-galvanized metal. In some embodiments, the thickness of the unibody piece of metal 212 may be between two millimeters (mm) and six mm. For example, the thickness of the unibody piece of metal 212 may be equal to or less than 4.5 mm. In some embodiments, the unibody piece of metal 212 may be approximately 4 mm. In some embodiments, the unibody piece of metal 212 may include a high strength metal. For example, the unibody piece of metal 212 may include a grade eighty metal or a metal with a yield strength equal to or greater than eight thousand pounds per square inch.

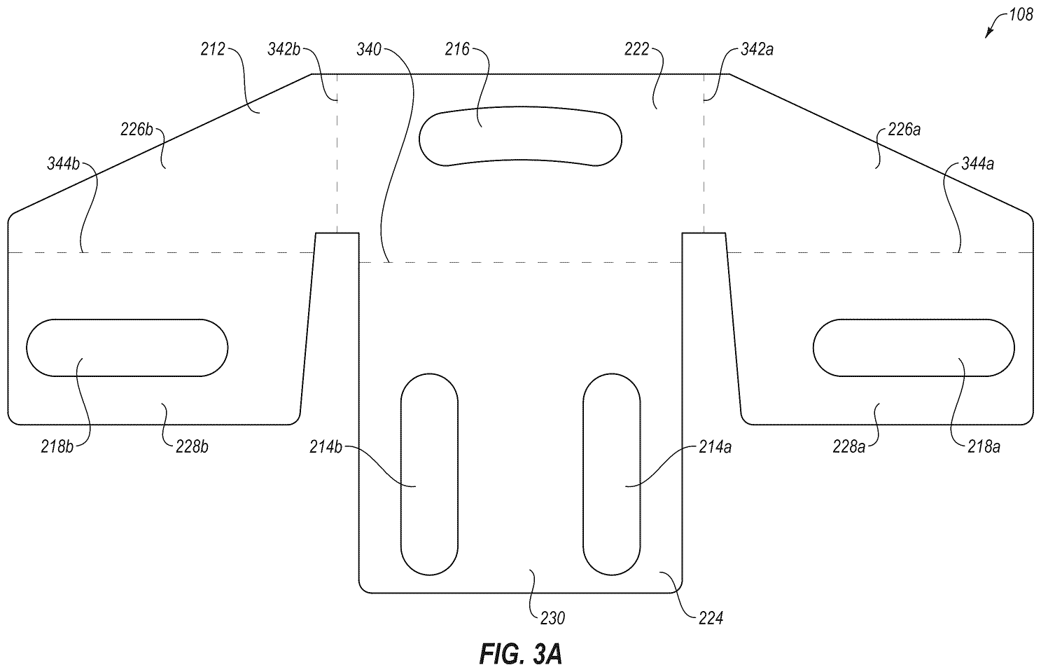

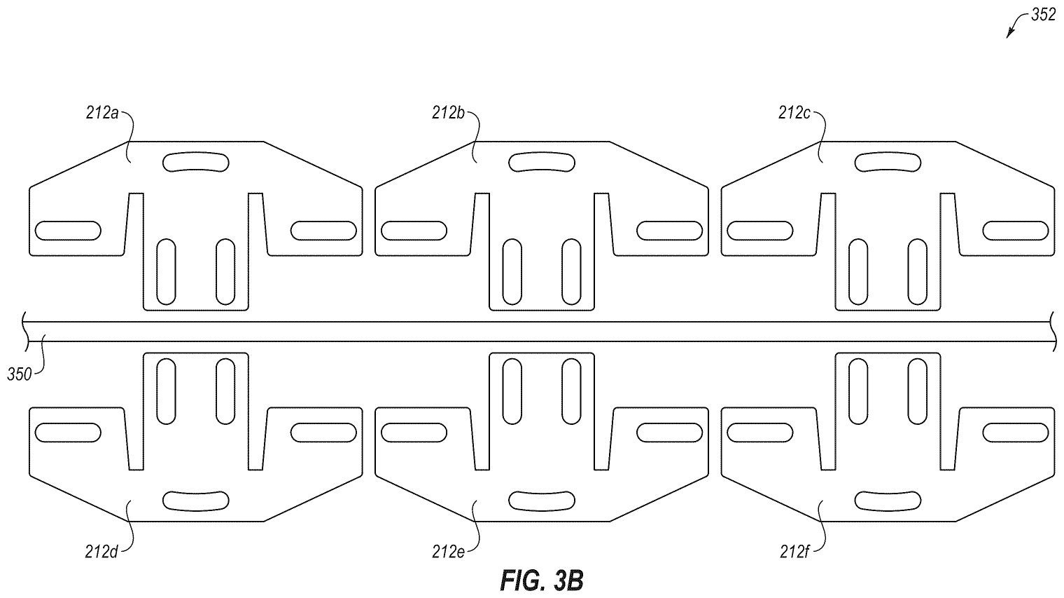

The unibody piece of metal 212 may be bent along lines (such as those denoted at 340, 342a-b, and 344a-b in FIG. 3A) to form multiple joints 236a-e that connect various portions of the mounting bracket 108. For example, a first joint 236a may connect a first portion 224 to a second portion 222; a second joint 236b may connect the second portion 222 to a first sidewall 226a; a third joint 236c may connect the second portion 222 to a second sidewall 226b, a fourth joint 236d may connect the first sidewall 226a to a first rigid body 228a; and a fifth joint 236e may connect the second sidewall 226b to a second rigid body 228b. The unibody piece of metal 212 may be bent such that a portion of the second face 232 is positioned to physically engage with the support column 106. In addition, the unibody piece of metal 212 may be bent such that corner openings 238a-b are formed. The corner openings 238a-b eliminate corners being formed in the unibody piece of metal 212 which may reduce a complexity of forming the mounting bracket 108.

Each of the joints 236a-e may include a radius of curvature. In some embodiments, the radius of curvature of each of the joints 236a-e may be the same. In other embodiments, the radius of curvature of each of the joints 236a-e may be different. Alternatively, the radius of curvature of one or more of the joints 236a-e may be different than one or more of the other joints 236a-e.

The unibody piece of metal 212 may be sized and shaped to permit the joints 236a-e to be bent beyond the bent state (generally referred to as being overbent) to account for spring back of the unibody piece of metal 212. Spring back may occur due to differences in stress (e.g., compressive forces) on interior portions of the joints 236a-e being different than stress (e.g., tensile forces) on exterior portions of the joints 236a-e during bending of the unibody piece of metal 212. The joints 236a-e being overbent may permit the unibody piece of metal 212 to be bent to bending angles at the joints 236a-e and spring back to bent angles at the joints 236a-e (e.g., the bent state) as illustrated in FIGS. 2A-2E.

The first portion 224 includes a surface 223 that interfaces with a surface of the support column 106. The surface 223 of the first portion 224 may interface with the surface of the support column 106 to position the mounting brackets 108a-b relative to the support column 106. In addition, the second portion 222 includes a surface 221 that interfaces with a surface of the torque tube interface 109. The surface 221 of the second portion 222 may interface with the surface of the torque tube interface 109 to position the torque tube interface 109 relative to the mounting brackets 108a-b and the support column 106 during installation.

The first portion 224 may include a first opening 214a and a second opening 214b (generally referred to in the present disclosure as openings 214). The openings 214 are illustrated in FIGS. 2A-2C as straight slots, but the openings 214 may include different configurations. The openings 214 may include a hole, a straight slot, or any other appropriate shape. The support column 106 may include openings that correspond to the openings 214 of the first portion 224. The openings of the support column 106 and the openings 214 of the first portion 224 may be configured to receive fasteners (not illustrated) to couple the mounting bracket 108 to the support column 106.

The second portion 222 may include an opening 216. While described as an opening 216, it will be appreciated that an alternative feature may be used, such as a post, a bolt, a screw, a slot, or a fastener formed into the mounting bracket 108 that interfaces with the torque tube interface 109. The second portion 222 may extend away from the first portion 224 at a nonparallel angle such that the opening 216 is on a different plane than the openings 214. For example, the second portion 222 may extend away from the first portion 224 such that the opening 216 is on a plane that is perpendicular to a plane of the openings 214. The opening 216 is illustrated in FIGS. 2A, 2D, and 2E, as a radial slot, but the opening 216 may include different configurations. For example, the opening 216 may include a hole, a straight slot, or any other appropriate shape.

The torque tube interface 109 may include an opening that corresponds to the opening 216 of the second portion 222. The opening of the torque tube interface 109 and the opening 216 of the second portion 222 may be configured to receive fasteners (not illustrated) to couple the torque tube interface 109 to the mounting bracket 108. In this way, the mounting bracket 108 facilitates the connection of the torque tube 102 (via the torque tube interface 109) to the support column 106.

The first sidewall 226a and the second sidewall 226b may extend away from the second portion 222 at nonparallel angles. In addition, the first sidewall 226a may extend away from the second portion 222 such that a nonparallel angle is formed by the first sidewall 226a and the first portion 224. Further, the second sidewall 226b may extend away from the second portion 222 such that a nonparallel angle is formed by the second sidewall 226b and the first portion 224.

The first rigid body 228a may extend away from the first sidewall 226a at a nonparallel angle. In addition, the second rigid body 228b may extend away from the second sidewall 226b at a nonparallel angle. In some embodiments, the first rigid body 228a and the second rigid body 228b may be parallel to each other. In the bent state, the first rigid body 228a and the second rigid body 228b may define a gap 220. The gap 220 may permit the unibody piece of metal 212 to be bent beyond the bent state at the second joint 236b or the third joint 236c even when the other joints 236a, 236d, 236e are in the bent state. The gap 220 may permit the unibody piece of metal 212 to be overbent at the second joint 236b or the third joint 236c by two degrees or more.

The first rigid body 228a and the second rigid body 228b may overlap different parts of the first portion 224 to form multilayer structures designated by arrows 234a-b. For example, the first rigid body 228a may overlap a first part of the first portion 224 to form a first multilayer structure 234a and the second rigid body 228b may overlap a second part of the first portion 224 to form a second multilayer structure 234b. The multilayer structures 234a-b may increase the strength of the mounting bracket 108. The multilayer structures 234a-b may permit the mounting bracket 108 to withstand the loads created by the solar tracking system 100 or the external factors when coupled to the support column 106. For example, the multilayer structures 234a-b may permit the mounting bracket 108 to withstand a load created by the weight of the components of the solar tracking system 100 or the weight of dirt, branches, water, or snow on the components. As another example, the multilayer structures 234a-b may permit the mounting bracket 108 to withstand a torque or torsional moment created by rotation of the torque tube 102 (in a solar tracking system) or a drag load created by wind blowing across PV panels of the solar tracking system 100.

Starting from the unibody piece of metal 212 in the pre-bent state, as illustrated in FIG. 3A, the first face 230 and the second face 232 are on opposite sides of the unibody piece of metal 212. As the unibody piece of metal 212 is bent to form the mounting bracket 108, regions of the first face 230 and regions of the second face 232 may become adjacent to or abut each other. For example, the first rigid body 228a may overlap the first part of the first portion 224 such that a first region of the second face 232 that corresponds to the first rigid body 228a is adjacent to a second region of the first face 230 that corresponds to the first part of the first portion 224. As another example, the second rigid body 228b may overlap the second part of the first portion 224 such that a third region of the second face 232 that corresponds to the second rigid body 228b is adjacent to a fourth region of the first face 230 that corresponds to the second part of the first portion 224.

The first rigid body 228a may include a third opening 218a and the second rigid body 228b may include a fourth opening 218b. The first rigid body 228a may be proximate to the first portion 224 such that the third opening 218a is positioned proximate and aligned relative to the first opening 214a. The second rigid body 228b may be proximate to the first portion 224 such that the fourth opening 218b is positioned proximate and aligned relative to the second opening 214b. The third opening 218a may be positioned proximate to the first opening 214a and the fourth opening 218b may be positioned proximate to the second opening 214b to receive fasteners (not illustrated in FIGS. 2A-2E) to couple the mounting bracket 108 to the support column. In some embodiments, the fasteners may draw the first rigid body 228a and the second rigid body 228b towards the first portion 224 to couple the first rigid body 228a and the second rigid body 228b to the support column 106. For example, the second rigid body 228b may be indirectly coupled to the support column 106 via the first portion 224 and the fasteners.

In some embodiments, the third opening 218a and the fourth opening 218b may be sized to compensate for discrepancies in the radiuses of curvature of the joints 236a-e. The third opening 218a and the fourth opening 218b may be sized to permit the openings 214, the third opening 218a, and the fourth opening 218b to receive the fasteners if the openings 214, the third opening 218a, and the fourth opening 218b are not precisely coaxial. For example, the third opening 218a may be sized to permit the first opening 214a and the third opening 218a to receive a fastener if the first opening 214a and the third opening 218a are not precisely coaxial. As another example, the fourth opening 218b may be sized to permit the second opening 214b and the fourth opening 218b to receive a fastener if the second opening 214b and the fourth opening 218b are not precisely coaxial. In some embodiments, the third opening 218a may be oversized compared to the first opening 214a and the fourth opening 218b may be oversized compared to the second opening 214b. In other embodiments, the first opening 214a may be oversized compared to the third opening 218a and the second opening 214b may be oversized compared to the fourth opening 218b.

With further reference to FIGS. 1-3A, the unibody piece of metal 212 may be bent along a midline 340 to form the first portion 224 and the second portion 222. In addition, the unibody piece of metal 212 may be bent along sidelines 342a-b to form the first sidewall 226a and the second sidewall 226b. For example, the unibody piece of metal 212 may be bent along a first sideline 342a to form the first sidewall 226a and a second sideline 342b to form the second sidewall 226b. The second sideline 342b may positioned on an end of the second portion 222 opposite the first sideline 342a.

The unibody piece of metal 212 may be bent along body lines 344a-b to form the first rigid body 228a and a second rigid body 228b. For example, the unibody piece of metal 212 may be bent along a first body line 344a to form the first rigid body 228a and along a second body line 344b to form the second rigid body 228b.

The unibody piece of metal 212 may be bent along the midline 340, the sidelines 342a-b, or the body lines 344a-b such that each resulting joints 236a-e may be overbent to account for spring back of the unibody piece of metal 212. For example, the unibody piece of metal 212 may be overbent along the midline 340, the sidelines 342a-b, the body lines 344a-b, or some combination thereof by two or more degrees to permit the unibody piece of metal 212 to spring back to the bent state as illustrated in FIGS. 2A-2E.

The mounting bracket 108 may be bent along the body lines 340, 342a-b, and 344a-b to form the joints 236a-e. In some embodiments, the body lines 342a-b that form the joints 236b-c may be parallel. In some embodiments, the body lines 344a-b that form the joints 236d-e may be colinear. In some embodiments, one or both of the body lines 344a-b that form the joints 236d-e may be non colinear but parallel with the body line 340 that forms the joint 236a. One or both of the body lines 344a-b may be offset from the body line 340 by at least the thickness of the mounting bracket 108. This allows the first and second rigid bodies 228a-b to be folded to overlap in whole or in part with the first portion 224. In some embodiments, the body lines 342b-c may be orthogonal to the body lines 340 and 344a-b.

With reference to FIG. 3B, an example form 352 of multiple examples of the mounting bracket 108 of FIG. 1 in the pre-bent state are shown. The form 352 includes multiple unibody pieces of metal 212a-f that are cut from a single sheet of pre-galvanized metal. In addition, a carrier tab 350 may be cut from the single sheet of pre-galvanized metal. The carrier tab 350 may be connected to the unibody pieces of metal 212a-f and may permit the unibody pieces of metal 212a-f to be physically moved during the manufacturing process of cutting the unibody pieces of metal 212a-f, bending the unibody pieces of metal 212a-f, cutting openings in the unibody pieces of metal 212a-f, or some combination thereof. During the manufacturing process, the unibody pieces of metal 212a-f may be disconnected from the carrier tab 350.

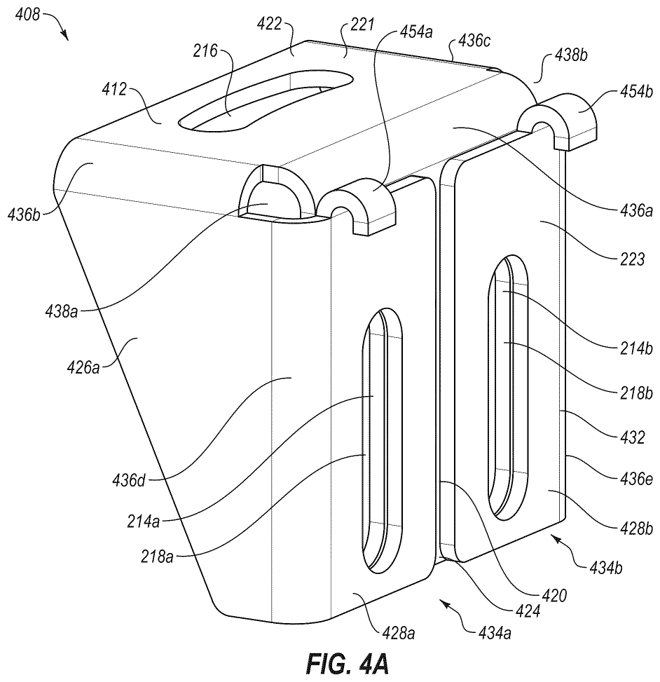

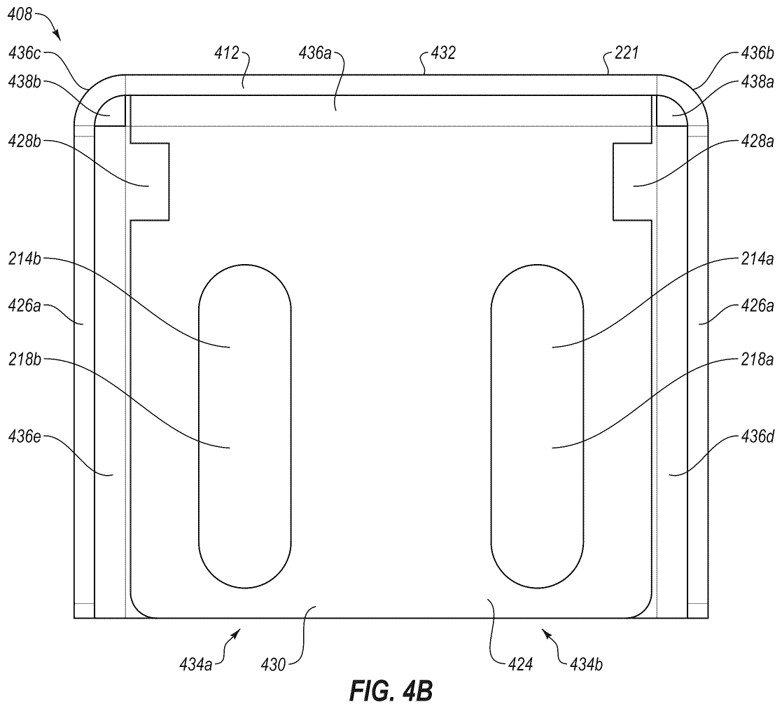

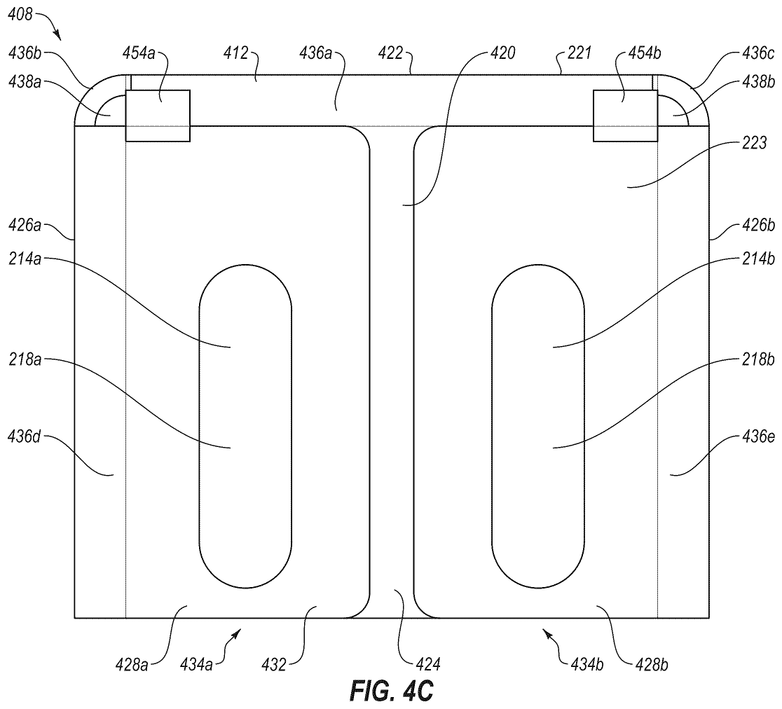

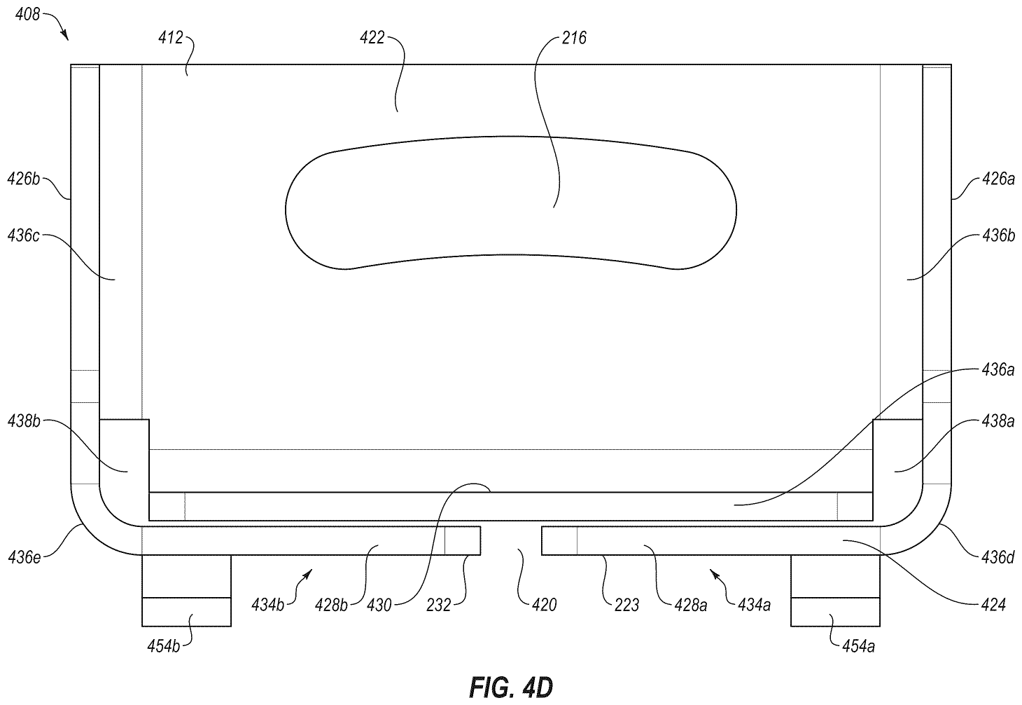

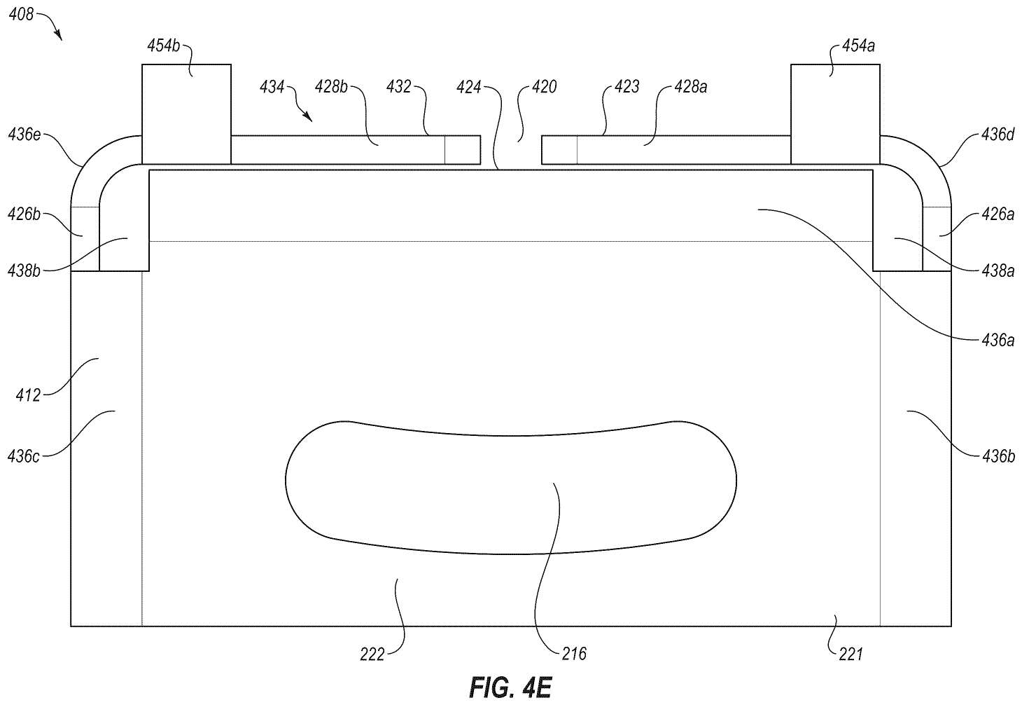

With reference to FIGS. 4A-4E, another example mounting bracket 408 is shown. The mounting bracket 408 may include a unibody piece of metal 412 that is cut, punched, or otherwise removed from a single sheet of pre-galvanized metal. The unibody piece of metal 412 may be cut from the single sheet of pre-galvanized metal such that the galvanization process protects the entire depth of the unibody piece of metal 412 between a first face 430 and a second face 432. The second face 432 may be on an opposite side of the unibody piece of metal 412 as the first face 430.

The thickness of the unibody piece of metal 412 may permit the unibody piece of metal 412 to be bent, cut, or stamped to form the mounting bracket 408 without exposing unprotected portions of the unibody piece of metal 412. For example, the unibody piece of metal 412 may be cut to create the openings 214a-b, 216, 218a-b without exposing the unprotected portions. In other words, the unibody piece of metal 412 may be manipulated while retaining the galvanization pre-treatment that was performed on the single sheet of pre-galvanized metal. In some embodiments, the thickness of the unibody piece of metal 412 may be between two mm and six mm. In some embodiments, the unibody piece of metal 412 may include a high strength metal. The first portion 424 may include the openings 214. The second portion 422 may include the opening 216. In some embodiments, the fasteners may draw the first portion 224 towards the first rigid body 228a and the second rigid body 228b to couple the first portion 224 to the support column 106. For example, the first portion 224 may be indirectly coupled to the support column 106 via one fastener and the first rigid body 228a at one part and via another fastener and the second rigid body 228b at another part.

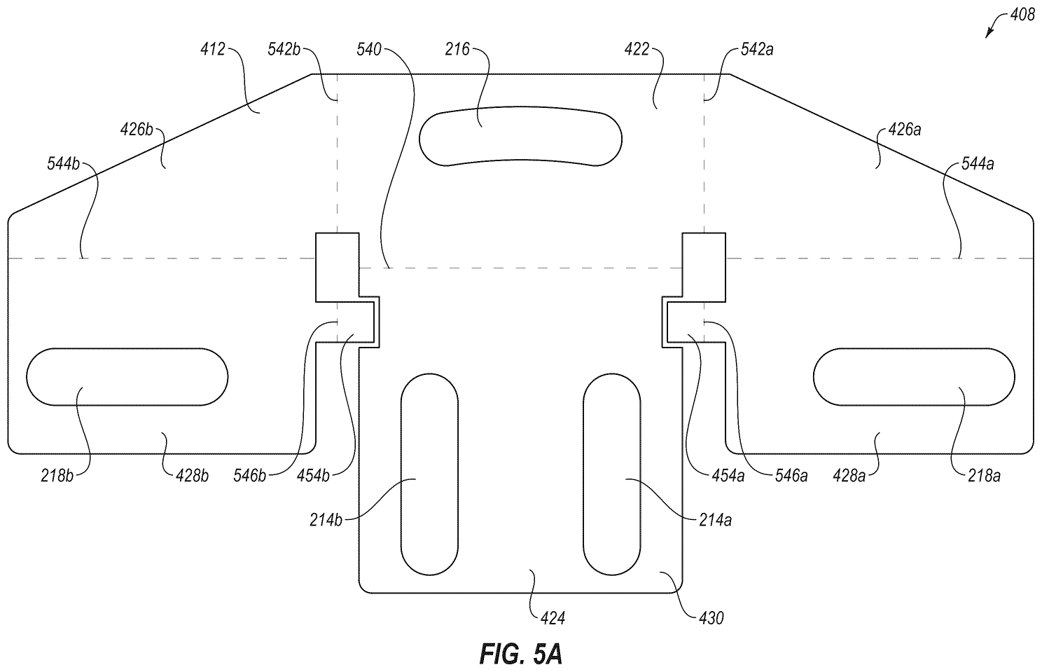

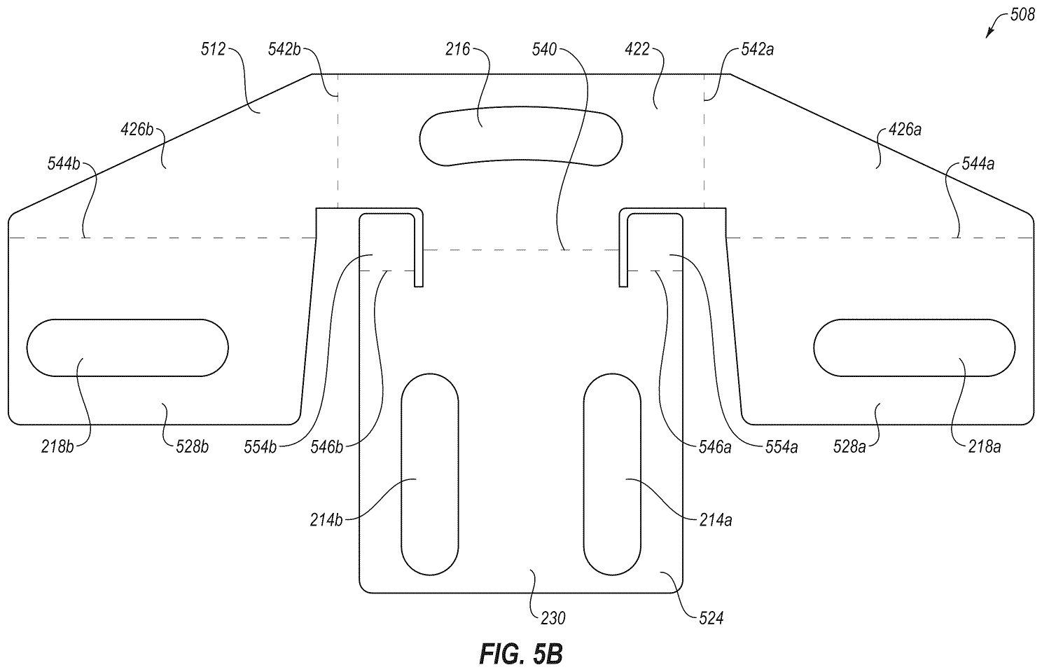

The unibody piece of metal 412 may be bent along lines (such as those denoted at 540, 542a-b, and 544a-b in FIG. 5A) to form multiple joints 436a-e that connect various portions of the mounting bracket 408. For example, a first joint 436a may connect a first portion 424 to a second portion 422; a second joint 436b may connect the second portion 422 to a first sidewall 426a; a third joint 436c may connect the second portion 422 to a second sidewall 426b, a fourth joint 436d may connect the first sidewall 426a to a first rigid body 428a; and a fifth joint 436e may connect the second sidewall 426b to a second rigid body 428b.

The unibody piece of metal 412 may be bent such that portions of the second face 432 are positioned to physically engage with the support column 106. In addition, the unibody piece of metal 412 may be bent such that corner openings 438a-b are formed. The corner openings 438a-b eliminate corners being formed in the unibody piece of metal 412 which may reduce a complexity of forming the mounting bracket 408.

Each of the joints 436a-e may include a radius of curvature. In some embodiments, the radius of curvature of each of the joints 436a-e may be the same. In other embodiments, the radius of curvature each of the joints 436a-e may be different. Alternatively, the radius of curvature of one or more of the joints 436a-e may be different than one or more of the other joints 436a-e. The unibody piece of metal 412 may be sized and shaped to permit the joints 436a-e to be overbent to account for spring back of the unibody piece of metal 412.

The second portion 422 may extend away from the first portion 424 at a nonparallel angle such that the opening 216 is on a different plane than the openings 214. For example, the second portion 422 may extend away from the first portion 424 such that the opening 216 is on a plane that is perpendicular to a plane of the openings 214.

The first sidewall 426a and the second sidewall 426b may extend away from the second portion 422 at nonparallel angles. In addition, the first sidewall 426a may extend away from the second portion 422 such that a nonparallel angle is formed by the first sidewall 426a and the first portion 424. Further, the second sidewall 426b may extend away from the second portion 422 such that a nonparallel angle is formed by the second sidewall 426b and the first portion 424.

The first rigid body 428a may extend away from the first sidewall 426a at a nonparallel angle. In addition, the second rigid body 428b may extend away from the second sidewall 426b at a nonparallel angle. In some embodiments, the first rigid body 428a and the second rigid body 428b may be parallel. In the bent state, the first rigid body 428a and the second rigid body 428b may define a gap 420. The gap 420 may permit the unibody piece of metal 412 to be bent beyond the bent state at the second joint 436b or the third joint 436c even when the other joints 436a, 436d, 436e are in the bent state. The gap 420 may permit the unibody piece of metal 412 to be overbent at the second joint 436b or the third joint 436c by two degrees or more.

The first rigid body 428a and the second rigid body 428b may overlap different parts of the first portion 424 to form multilayer structures designated by arrows 434a-b. For example, the first rigid body 428a may overlap a first part of the first portion 424 to form a first multilayer structure 434a and the second rigid body 428b may overlap a second part of the first portion 424 to form a second multilayer structure 434b. The multilayer structures 434a-b may increase a strength of the mounting bracket 408. The multilayer structures 434a-b may permit the mounting bracket 408 to withstand the loads created by the solar tracking system 100 or the external factors when coupled to the support column 106.

Starting from the unibody piece of metal 412 in the pre-bent state, as illustrated in FIG. 5A, the first face 430 and the second face 432 are on opposite sides of the unibody piece of metal 412. As the unibody piece of metal 412 is bent to form the mounting bracket 408, regions of the first face 430 and regions of the second face 432 may become adjacent to or abut each other. For example, the first rigid body 428a may overlap the first part of the first portion 424 such that a first region of the first face 430 that corresponds to the first rigid body 428a is adjacent to a second region of the second face 432 that corresponds to the first part of the first portion 424. As another example, the second rigid body 428b may overlap the second part of the first portion 424 such that a third region of the first face 430 that corresponds to the second rigid body 428b is adjacent to a fourth region of the second face 432 that corresponds to the second part of the first portion 424.

The first rigid body 428a may include the third opening 218a and the second rigid body 428b may include the fourth opening 218b. The first rigid body 428a may be proximate to the first portion 424 such that the third opening 218a is positioned proximate and aligned relative to the first opening 214a. The second rigid body 428b may be proximate to the first portion 424 such that the fourth opening 218b is positioned proximate and aligned relative to the second opening 214b. In some embodiments, the third opening 218a and the fourth opening 218b may be sized to compensate for discrepancies in the radiuses of curvature of the joints 436a-e.

The attachment tabs 454a-b may receive ends of the support column 106 such that the mounting bracket 408 hangs from and is supported by the support column 106. In addition, the attachment tabs 454a-b may receive the ends of the support column 106 to maintain alignment of the mounting bracket 408 relative to the support column 106.

In some embodiments, the attachment tabs 454a-b may be omitted and the mounting bracket 408 may operate the same as or similar to the mounting bracket 108 of FIG. 1 but with the first rigid body 428a and the second rigid body 428b physically engaging the support column 106 instead of the first portion 424.

With further reference to FIGS. 4A-5A, the unibody piece of metal 412 may be bent along a midline 540 to form the first portion 424 and the second portion 422. In addition, the unibody piece of metal 412 may be bent along sidelines 542a-b to form the first sidewall 426a and the second sidewall 426b. For example, the unibody piece of metal 412 may be bent along a first sideline 542a to form the first sidewall 426a and a second sideline 542b to form the second sidewall 426b. The second sideline 542b may positioned on an end of the second portion 422 opposite the first sideline 542a.

The unibody piece of metal 412 may be bent along body lines 544a-b to form the first rigid body 428a and a second rigid body 428b. For example, the unibody piece of metal 412 may be bent along a first body line 544a to form the first rigid body 428a and along a second body line 544b to form the second rigid body 428b. In addition, the unibody piece of metal 412 may be bent along attachment lines 546a-b to form the attachment tabs 454a-b. For example, the unibody piece of metal 412 may be bent along a first attachment line 546a to form the first attachment tab 454a and along a second attachment line 546b to form the second attachment tab 454b.

The unibody piece of metal 412 may be bent along the midline 540, the sidelines 542a-b, or the body lines 544a-b such that each resulting joint 436a-e may be overbent to account for spring back of the unibody piece of metal 412. For example, the unibody piece of metal 412 may be overbent along the midline 540, the sidelines 542a-b, or the body lines 544a-b by two or more degrees to permit the unibody piece of metal 412 to spring back to the bent state as illustrated in FIGS. 4A-4E.

With reference to FIG. 5B, another example mounting bracket 508 including example attachment tabs 454a-b in the pre-bent state is shown. The unibody piece of metal 512 may be cut from the single sheet of pre-galvanized metal and progressively bent to form the mounting bracket 508 in the bent state.

The unibody piece of metal 512 may be bent along the midline 540 to form a first portion 524 and the second portion 422. In addition, the unibody piece of metal 512 may be bent along sidelines 542a-b to form the first sidewall 426a and the second sidewall 426b. For example, the unibody piece of metal 512 may be bent along the first sideline 542a to form the first sidewall 426a and the second sideline 542b to form the second sidewall 426b. The second sideline 542b may positioned on an end of the second portion 422 opposite the first sideline 542a.

The unibody piece of metal 512 may be bent along body lines 544a-b to form a first rigid body 528a and a second rigid body 528b. For example, the unibody piece of metal 512 may be bent along the first body line 544a to form the first rigid body 528a and along the second body line 544b to form the second rigid body 528b. In addition, the unibody piece of metal 512 may be bent along the attachment lines 546a-b to form attachment tabs 554a-b. For example, the unibody piece of metal 512 may be bent along the first attachment line 546a to form a first attachment tab 554a and along the second attachment line 546b to form the second attachment tab 554b. The attachment tabs 554a-b may operate the same as or similar to the attachment tabs 454a-b of the mounting bracket 408 of FIGS. 4A-5A.

The unibody piece of metal 512 may be bent along the midline 540, the sidelines 542a-b, or the body lines 544a-b such that resulting joints may be overbent to account for spring back of the unibody piece of metal 512. For example, the unibody piece of metal 512 may be overbent along the midline 540, the sidelines 542a-b, or the body lines 544a-b by two or more degrees to permit the unibody piece of metal 512 to spring back to the bent state.

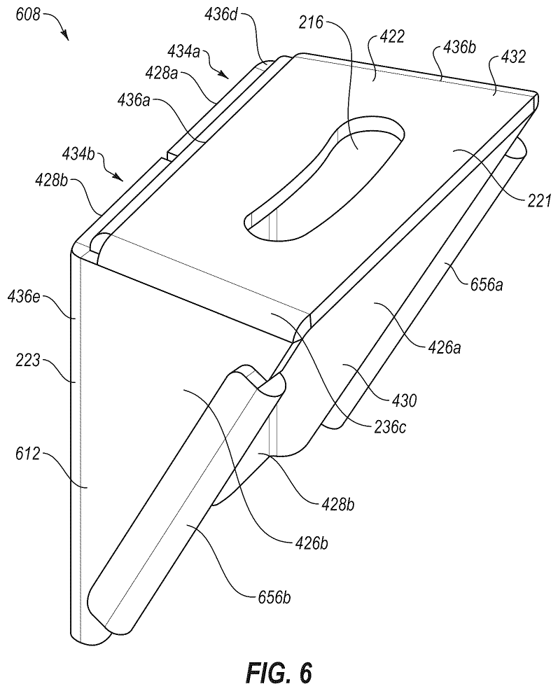

With reference to FIG. 6, an example mounting bracket 608 including hems 656a-b is shown. The mounting bracket 608 may operate the same as or similar to the mounting bracket 408 of FIGS. 4A-5A. The hems 656a-b of the mounting bracket 608 may increase a strength of the mounting bracket 608. FIG. 6 illustrates the mounting bracket 608 in the bent state. The mounting bracket 608 may include a unibody piece of metal 612 that is cut, punched, or otherwise removed from a single sheet of pre-galvanized metal. The unibody piece of metal 612 may be cut from the single sheet of pre-galvanized metal such that the galvanization process protects the entire depth of the unibody piece of metal 612 between the first face 430 and the second face 432.

The thickness of the unibody piece of metal 612 may permit the unibody piece of metal 612 to be bent, cut, or stamped to form the mounting bracket 608 without exposing unprotected portions of the unibody piece of metal 612. For example, the unibody piece of metal 612 may be cut to create the openings 214a-b, 216, 218a-b without exposing the unprotected portions. In other words, the unibody piece of metal 612 may be manipulated while retaining the galvanization pre-treatment that was performed on the single sheet of pre-galvanized metal. In some embodiments, the thickness of the unibody piece of metal 612 may be between two mm and six mm. In some embodiments, the unibody piece of metal 612 may include a high strength metal. The first portion 424 may include the openings 214. The second portion 422 may include the opening 216.

The unibody piece of metal 612 may be bent along lines to form the joints 436a-e. The unibody piece of metal 612 may be bent such that portions of the second face 432 are positioned to physically engage with the support column 106.

The first rigid body 428a and the second rigid body 428b may overlap different parts of the first portion 424 to form the multilayer structures 434a-b. The multilayer structures 434a-b may permit the mounting bracket 608 to withstand the loads created by the solar tracking system 100 or the external factors when coupled to the support column 106. The hems 656a-b may be formed to increase a strength of the sidewalls 426a-b.

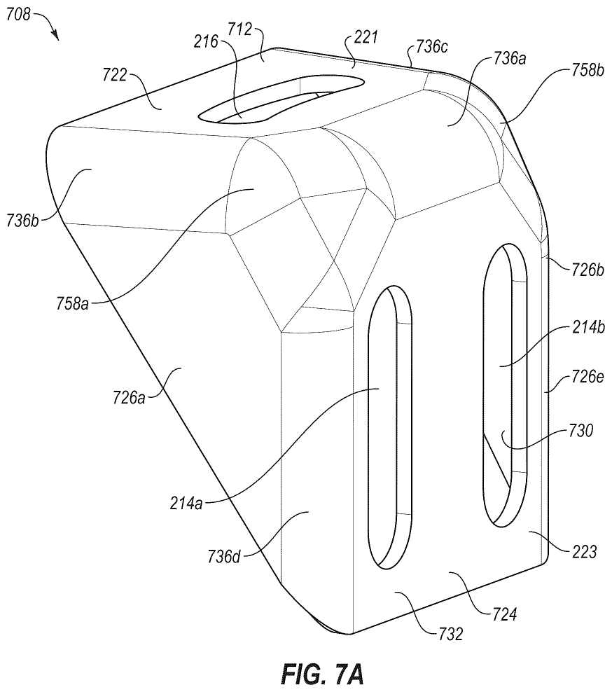

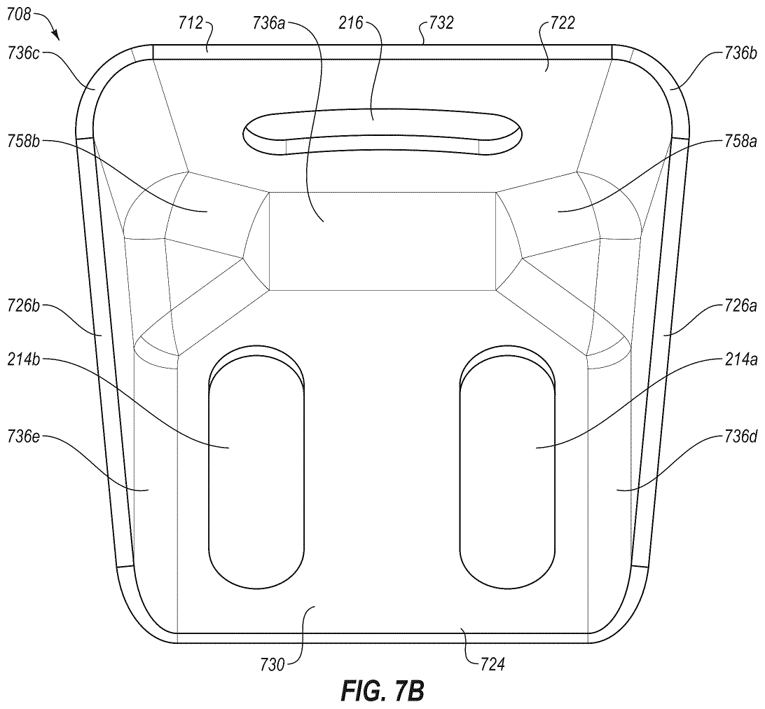

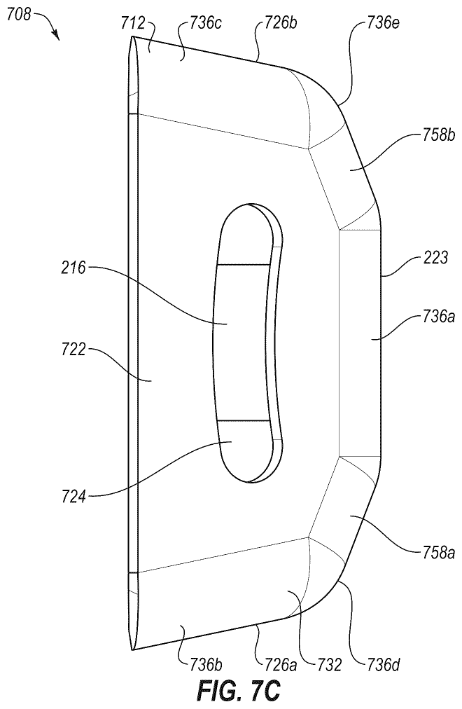

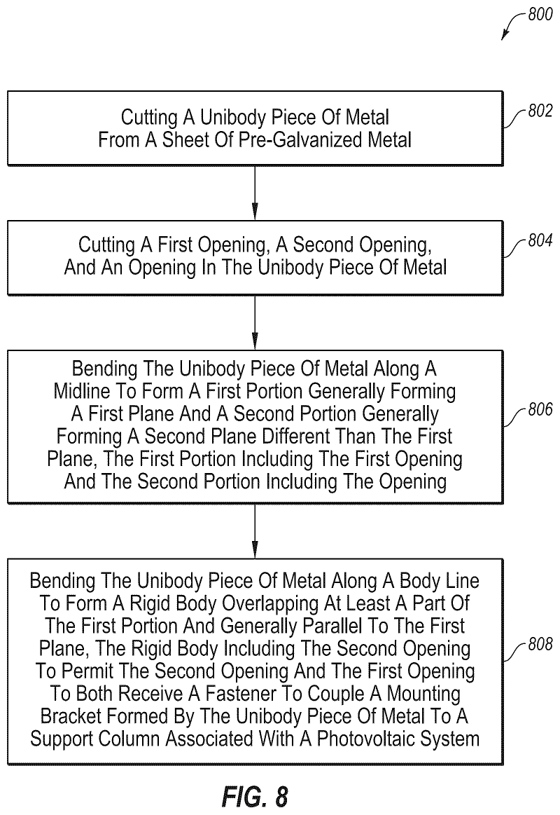

With reference to FIGS. 7A-7C, an example drawn mounting bracket 708 is shown. The mounting bracket 708 may be formed using deep drawn stamping in which a unibody piece of metal 712 is formed using compressive forces and tensile forces. The unibody piece of metal 712 may be cut, punched, or otherwise removed from a single sheet of pre-galvanized metal. The unibody piece of metal 712 may be cut from the single sheet of pre-galvanized metal such that the galvanization process protects the entire depth of the unibody piece of metal 712 between a first face 730 and a second face 732. The second face 732 may be on an opposite side of the unibody piece of metal 712 as the first face 730.

The thickness of the unibody piece of metal 712 may permit the unibody piece of metal 712 to be drawn or cut to form the mounting bracket 708 without exposing unprotected portions of the unibody piece of metal 712. For example, the unibody piece of metal 712 may be cut to create the openings 214a-b, 216, 218a-b without exposing the unprotected portions. In other words, the unibody piece of metal 712 may be manipulated while retaining the galvanization pre-treatment that was performed on the single sheet of pre-galvanized metal. In some embodiments, the unibody piece of metal 712 may include a high strength metal. For example, the unibody piece of metal 712 may include a grade fifty metal.

The unibody piece of metal 712 may be drawn to form multiple joints 736a-e that connect various portions of the mounting bracket 708. For example, a first joint 736a may connect a first portion 724 to a second portion 722; a second joint 736b may connect the second portion 722 to a first sidewall 726a; a third joint 736c may connect the second portion 722 to a second sidewall 726b, a fourth joint 736d may connect the first sidewall 726a to the first portion 724; and a fifth joint 236e may connect the second sidewall 726b to the first portion 724.

The unibody piece of metal 712 may be drawn such that a portion of the second face 732 is positioned to physically engage with the support column 106. In addition, the unibody piece of metal 712 may be drawn such that corners 758a-b are formed.

Each of the joints 736a-e may include a radius of curvature. In some embodiments, the radius of curvature of each of the joints 736a-e may be greater than the radiuses of curvature of the joints 236a-e of the mounting bracket 108 of FIGS. 1-3B.

The first portion 724 may include the openings 214. The second portion 722 may extend away from the first portion 724 at a nonparallel angle such that the opening 216 is on a different plane than the openings 214.

The first sidewall 726a and the second sidewall 726b may extend away from the second portion 722 at nonparallel angles. In addition, the first sidewall 726a may extend away from the second portion 722 such that a nonparallel angle is formed by the first sidewall 726a and the first portion 724. Further, the second sidewall 726b may extend away from the second portion 722 such that a nonparallel angle is formed by the second sidewall 726b and the first portion 724.

FIG. 8 illustrates a flowchart of an example method 800. The method 800 may include one or more blocks 802, 804, 806, or 808. Although illustrated with discrete blocks, the steps and operations associated with one or more of the blocks of the method 800 may be divided into additional blocks, combined into fewer blocks, or eliminated, depending on the particular implementation.

At block 802, a unibody piece of metal may be cut from a sheet of pre-galvanized metal. At block 804, a first opening, a second opening, and an opening may be cut in the unibody piece of metal. At block 806, the unibody piece of metal may be along a midline to form a first portion generally forming a first plane and a second portion generally forming a second plane different than the first plane, the first portion including the first opening and the second portion including the opening. At block 808, the unibody piece of metal may be bent along a body line to form a rigid body overlapping at least a part of the first portion and generally parallel to the first plane, the rigid body including the second opening to permit the second opening and the first opening to both receive a fastener to couple a mounting bracket formed by the unibody piece of metal to a support column associated with a photovoltaic system

Thus, forming the mounting bracket using the unibody pieces of metal 212, 412, 512, 612, and/or 712 can simplify the manufacturing process by removing the step of individually treating each mounting brackets to prevent corrosion due to the environmental factors while providing a mounting bracket able to withstand the loads experienced during operation.

1. A mounting bracket for connecting solar components in a photovoltaic (PV) system, the mounting bracket comprising:
a first portion defining a first opening that is configured to receive a first fastener to couple the first portion to a support column;
a second portion defining a second opening that is configured to receive a second fastener to couple the second portion to a solar component; and
a rigid body overlapping at least part of the first portion, the rigid body defining a third opening that aligns at least in part with the first opening and is configured to receive the first fastener to couple the rigid body to the support column;
wherein, the first portion, the second portion, and the rigid body are made from a unibody piece of metal.

2. The mounting bracket of claim 1, wherein:
the rigid body is configured to directly engage with the support column; and
indirectly couple the first portion to the support column.

3. The mounting bracket of claim 1, wherein:
the first portion is configured to directly engage with the support column; and
indirectly couple the rigid body to the support column.

4. The mounting bracket of claim 1, further comprising a sidewall that is made from the unibody piece of metal.

5. The mounting bracket of claim 4, wherein the unibody piece of metal is bent to form the mounting bracket such that a plurality of joints are formed, the plurality of joints including:
a first joint between the first portion and the second portion;
a second joint between the second portion and the sidewall; and
a third joint between the sidewall and the rigid body.

6. The mounting bracket of claim 5, wherein none of the first, second, or third joints are colinear.

7. The mounting bracket of claim 4, further comprising a second sidewall and a second rigid body, wherein the second sidewall and the second rigid body are made from the unibody piece of metal.

8. The mounting bracket of claim 1, wherein the unibody piece of metal comprises a pre-galvanized metal comprising a thickness that permits a pre-treatment to protect an entire depth of the unibody piece of metal.

9. The mounting bracket of claim 8, wherein the thickness of the unibody piece of metal is less than 4.5 millimeters.

10. The mounting bracket of claim 9, wherein the thickness of the unibody piece of metal is approximately 4 millimeters.

11. A system comprising:
a torque tube;
a torque tube interface within which the torque tube rotates;
a support column supporting the torque tube interface and the torque tube;
a mounting bracket comprising:
a first portion defining a first opening that is configured to receive a first fastener to couple the first portion to the support column;
a second portion defining a second opening that is configured to receive a second fastener to couple the second portion to the torque tube interface; and
a rigid body overlapping at least part of the first portion, the rigid body defining a third opening that aligns at least in part with the first opening and is configured to receive the first fastener to couple the rigid body to the support column;
wherein, the first portion, the second portion, and the rigid body are made from a unibody piece of metal.

12. The system of claim 11, wherein:
the rigid body is configured to directly engage with the support column; and
indirectly couple the first portion to the support column.

13. The system of claim 11, wherein:
the first portion is configured to directly engage with the support column; and
indirectly couple the rigid body to the support column.

14. The system of claim 11, further comprising a sidewall that is made from the unibody piece of metal.

15. The system of claim 14, wherein the unibody piece of metal is bent to form the mounting bracket such that a plurality of joints are formed, the plurality of joints including:
a first joint between the first portion and the second portion;
a second joint between the second portion and the sidewall; and
a third joint between the sidewall and the rigid body.

16. The system of claim 15, wherein none of the first, second, or third joints are colinear.

17. The system of claim 14, further comprising a second sidewall and a second rigid body, wherein the second sidewall and the second rigid body are made from the unibody piece of metal.

18. The system of claim 11, wherein the unibody piece of metal comprises a pre-galvanized metal comprising a thickness that permits a pre-treatment to protect an entire depth of the unibody piece of metal.

19. The system of claim 18, wherein the thickness of the unibody piece of metal is less than 4.5 millimeters.

20. The system of claim 19, wherein the thickness of the unibody piece of metal is approximately 4 millimeters.
